(19) United States
(12) Patent Application Publication
(10) Pub. No.: US 2021/0170496 A1
(43) Pub. Date: Jun. 10, 2021

(54) TOOL HOLDER

(71) Applicant: Adolf KOCHSIEK, Leopoldshöhe (DE)

(72) Inventor: Adolf KOCHSIEK, Leopoldshöhe (DE)

(21) Appl. No.: 17/048,270

(22) PCT Filed: Apr. 9, 2019
(86) PCT No.: PCT/EP2019/058976

§ 371 Date: Oct. 16, 2020

(30) Foreign Application Priority Data
Apr. 17, 2018 (EP) 18167669.3

(51) Int. Cl. B23B 31/00

(52) U.S. Cl. CPC B23B 31/006; B23B 2231/0244

(57) ABSTRACT

The disclosure relates to a tool holder having a tool portion and a tool interface portion, wherein the tool interface portion has a lateral surface area which is of rotationally symmetrical design and extends over a predetermined axial length and wherein the tool interface portion has sections with non-round cross section.

### CROSS-REFERENCE TO RELATED APPLICATIONS

This application is a U.S. National Phase Application under 35 U.S.C. 371 of International Application No. PCT/EP2019/058976, filed on Apr. 9, 2019, which claims the benefit of European Patent Application No. 18167669.3, filed on Apr. 17, 2018. The entire disclosures of the above applications are incorporated herein by reference.

### FIELD

The disclosure relates to tool holders having a tool portion and a tool interface portion.

### BACKGROUND

This section provides background information related to the present disclosure which is not necessarily prior art.

Machine tools manufactured and used according to the state of the art have a spindle in which a tool is inserted. For reasons of economy, a tool-holding work spindle on a machine tool must allow for a tool change. Modern machine tools should work as automatically as possible and should therefore also be able to change the tool automatically. For example, they have turret systems or other tool magazines. For this reason, the tool requires a tool interface. The tool interface must have a very high repeat accuracy, i.e. the position of the same tool clamped two times in a row should preferably be the same. This accuracy has a direct effect on the machining accuracy. Inaccurate clamping can lead to imbalance and thus to production losses, etc.

The steep taper and the hollow shank taper have become established as machine-side tool holders, especially standardized ones. The hollow shank taper offers several advantages, especially at high speeds. However, steep taper tools are also widely used.

A tool clamping device is used for clamping and its function is to fix the tool after insertion. There are hydromechanical and mechanical systems, i.e. systems using spring force. The robust design of the plate spring clamping device is still a frequently used system. The tool is released via a hydraulic or pneumatic releasing unit which presses against the spring force at standstill and thus releases the tool.

Different systems are available as a tool interface, depending on the respective application. Here a difference must be made between individually designed interfaces and standardized tool interfaces such as the hollow shank taper (HSK) or the steep taper (SK). In the case of a milling spindle, the tool changes take place mostly automatically by pneumatic, hydraulic or electrical actuation.

In the past, the issue of the tool interface and the clamping system has been dealt with in various working groups as well as research and industrial projects. Since this time, a large number of interface systems (HSK, SK, Big+, Capto, KM etc.) have established themselves on the market, each of which has system-related advantages and disadvantages. In addition to the static properties, the behavior under the influence of speed is decisive, especially for rotary applications. Interfaces must be designed with regard to properties such as bending strength and suitability for speed.

As a direct link between the machine tool and the tool, the tool interface directly influences the performance and quality of the machining process. Depending on the process type, the processing forces act on the tool interface as longitudinal and transverse forces as well as bending and torsional moments. The magnitude of the torsional moment is determined by the relative position between the tool cutting edge and the center axis of the tool interface as well as the division of the cutting force into its components. The continuous increase of the spindle power leads to higher and higher machining forces and consequently to higher loads on the tool interfaces which are used.

An important evaluation criterion of tool interfaces is their behavior under static torsional load. Especially in turning, the use of static tools with large radial projection lengths leads to high torsional moments at the tool interface. The rotation of the tool relative to the holder, which is the result of torsional load, has an effect on the dynamic process behavior and the service life of the tool interface and the tool cutting edges in lathes and milling machines. In lathes, torsion also directly affects the center height of the cutting edge and thus the working accuracy of the machine.

The standardized milling interfaces SK (DIN 69871) and HSK-A (DIN 69893) and the likewise standardized combined turning and milling interfaces PSC (ISO 26623) and HSK-T (ISO 12164) are examples of the standard. The standardized VDI (DIN ISO 10889) is cited as the interface for lathe machining.

It turned out that the frictionally transmitted moment characterizes the load of the interface at which a relative movement between tool and holder takes place without further increase of the load. A contact zone is subsequently formed on the driver elements. A further increase of the load leads to a spring deflection at this contact and to an increase of the torsional rigidity. It is particularly noteworthy that a linear load deformation behavior is established upon full contact.

During machining, the tool interface is always located directly in the flow of force and should have a high rigidity and also permit a rapid tool change in order to keep non-productive times low.

The increasing machining forces result from constantly increasing driving powers and more demanding materials and cutting materials. This leads to increasing loads on the tool interface, which loads may damage the tool interfaces or exclude them from use due to insufficient rigidities and high accuracy requirements.

As can be seen from the above discussion, a material flow takes place due to the load deformation behavior. Therefore, at a full contact between the tool and the tool holder in the region of the tool interface, uncontrolled positioning occurs due to the material flow and the resulting overconstraining.

### SUMMARY

This section provides a general summary of the disclosure, and is not a comprehensive disclosure of its full scope or all of its features.

Based on the above-described prior art, it is an object of the present disclosure to further develop a tool holder of the type described in such a way that it is improved in particular with regard to its load deformation behavior, without loss of its other technical properties and qualities and while maintaining compatibility with the corresponding standards.

The technical solution consists in the tool interface portion having sections with non-round cross section. In this way, considerable advantages are achieved. During clamping, the interface portion is drawn into the holder, resulting in a material flow. The disclosure favors and promotes the possibility of elastic deformation. According to the disclosure, this is achieved by forming at least one depression on the lateral surface area in the tool interface portion of the tool holder. It has been shown that this interrupts the full contact between tool holder and tool interface and creates material flow spaces.

This is an elastic process, i.e. as soon as the load decreases, the tool holder is in its original shape. The clamping forces can be distributed more easily, which makes it possible to allow higher oversizes in the tool interface without the surface pressure falling outside the permissible ranges for elastic deformation. This creates an opportunity to make the tool interface stiffer and technically more advantageous. In addition, the formation of depressions can also improve automatic insertion and removal.

With HSK or SK interfaces, but also in general, it is advantageous to arrange depressions in a certain symmetry. It is advantageous that the depressions are clearly defined with regard to their radial penetration depth into the lateral surface area. The same applies to their axial extension in the axial direction of the lateral surface area as well as their length in the circumference of the lateral surface area. The depressions preferably represent a jump-free, clearly defined depression area.

The length along the circumference of the lateral surface area is defined by the center angle. According to an advantageous proposal of the disclosure, depressions lying at the same axial height all have the same center angle. In addition, they are spaced from each other by the same center angle. Of course, the center angles of the extension and the center angles of the distances to each other are different. In all corresponding systems subjected to torsion and bending, transmission flanks occur in the rotational sense so that intermediate depressions, e.g. depressions extending over the entire axial length, provide sufficient receiving spaces for the material flow.

Corresponding tool interfaces are usually segmented in the axial direction, i.e. they have areas of different cylindrical or conical design. In these segments, the depressions are correspondingly evenly arranged so that different axial areas of non-round cross section are formed in the different planes.

The disclosure provides a solution that can be implemented with little technical effort to increase the effectiveness of the use of corresponding tool holders.

In accordance with the disclosure, the rotationally symmetrical lateral surface areas can be machined in a non-circular turning process in order to produce precisely positioned, precisely extended and, with regard to depth, clearly defined depressions in a very fast turning process.

### DRAWINGS

The drawings described herein are for illustrative purposes only of selected embodiments and not all possible implementations, and are not intended to limit the scope of the present disclosure.

Further advantages and features of the disclosure will become apparent from the following description with reference to the attached drawings wherein it is shown by

FIG. 1 a representation of a tool holder according to the HSK system in a further development according to the disclosure;

FIG. 2 a representation of a tool holder according to the SK system in a further development according to the disclosure.

### DETAILED DESCRIPTION

Example embodiments will now be described more fully with reference to the accompanying drawings.

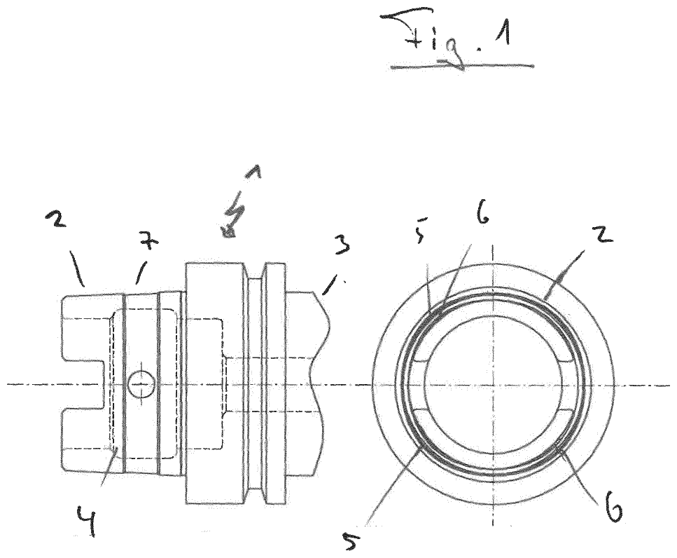

FIG. 1 shows a conventional tool holder 1 according to the HKS system having an interface portion 2 and a tool holder portion 3. The tool holder portion 3 is only indicated up to the cutting line and is otherwise standard.

In the usual manner, the inside progressions show the edges 4 for the engagement behind and drawing the tool holder into the tool mount of a machine tool and the like.

All these details are standard.

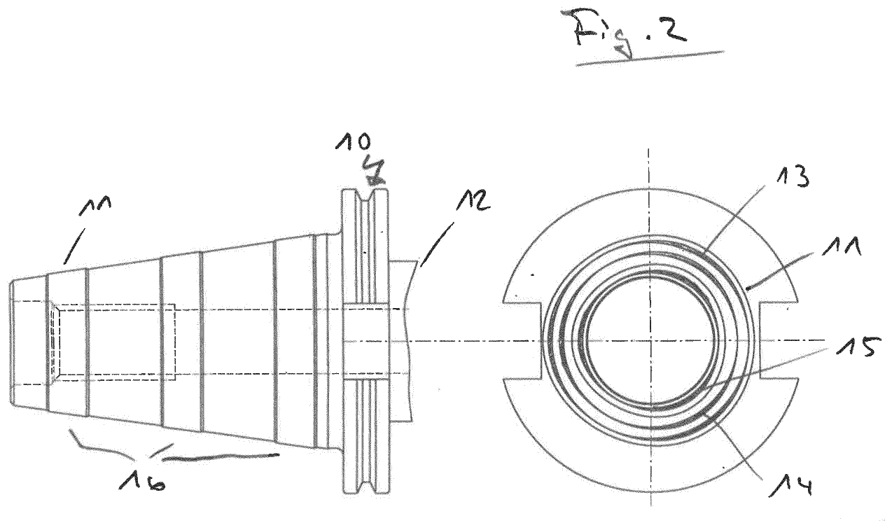

FIG. 2 shows in a corresponding manner the tool holder 10 according to the SK system having the interface portion 11 and the holder portion 12.

The representations on the right are subviews of the interface portions 2 and 11, respectively.

They show that, in deviation from the circular design, depressions 5 and 6 respectively 13, 14 and 15 are formed in the lateral surface area. This gives the individual axial steps a non-round cross-section that can be produced by a non-round turning process for example.

This non-round cross section has the effect that contact-free areas are formed in the depressions between the tool interface and the tool holder which allow a sufficient flow of material under load.

Reference numbers 7 or 16 indicate axially extending radial relief grooves which reduce the contact area between the tool and the tool interface to a necessary minimum. In this way, it can be achieved that due to the lower friction during the draw-in process, a higher clamping force can be brought to the face contact, which has a clear effect on the rigidity of the tool without losing compatibility with the standard, especially in the case of the HSK interface.

The embodiments described are for illustrative purposes only and are not limiting.

Notch effects can be avoided by selecting suitable non-round shapes. The number of depressions is as variable as the respective depth.

1. A tool holder having a tool portion and a tool interface portion, wherein the tool interface portion has a lateral surface area which is of rotationally symmetrical design and extends over a predetermined axial length, wherein the tool interface portion has sections with non-round cross section.

2. The tool holder according to claim 1, wherein the sections with non-round cross section are formed by depressions arranged in the lateral surface area.

3. The tool holder according to claim 1, wherein depressions arranged in a section plane which is perpendicular to the axis of rotation are positioned at equal angular distances to each other.

4. The tool holder according to claim 3, wherein the depressions have the same arc length in each axial plane.

5. The tool holder according to claim 1, wherein the axial extension, the radial depth, and the arc length are predefined for a depression.

6. The tool holder according to claim 1, wherein depressions of different shape and/or extension are arranged on the lateral surface.

7. The tool holder according to claim 6, wherein depressions of different shape and/or extension are arranged in a ring area.

8. The tool holder according to claim 1, wherein depressions extend over the entire axial length of the tool interface portion.

9. The tool holder according to claim 8, wherein the depressions have a different radial depth over their axial progression.

10. The tool holder according to claim 1, wherein axially extended depressions run at an angle to the axis of rotation of the tool holder.

11. The tool holder according to claim 1, wherein the number of depressions is variable in relation to the circumference.

12. The tool holder according to claim 11, wherein the number of depressions is between 3 and 10.

13. The tool holder according to claim 1, wherein the number of the optional axial relieves is variable.
